(19) United States
(12) Patent Application Publication
(10) Pub. No.: US 2012/0102940 A1
(43) Pub. Date: May 3, 2012

(54) BRAKE APPARATUS

(76) Inventors: Kentaro Ueno, Minami-ALPS-shi (JP); Yusuke Nozawa, Minami-ALPS-shi (JP); Yukihiko Yamada, Minami-ALPS-shi (JP); Daisuke Kojima, Minami-ALPS-shi (JP); Tohma Yamaguchi, Minami-ALPS-shi (JP)

(21) Appl. No.: 13/238,389

(22) Filed: Sep. 21, 2011

(30) Foreign Application Priority Data
Oct. 29, 2010 (JP) 244510/2010

(51) Int. Cl. B60T 8/171

(52) U.S. Cl. 60/537

(57) ABSTRACT

A brake apparatus capable of preventing generation of an unintended brake force. The brake apparatus includes an input member configured to be moved forward and backward by an operation of a brake pedal, a stroke detector for detecting an operation stroke of the input member, and a controller for controlling an actuator based on a detection result of the stroke detector. When the controller is set into the controllable state, the controller sets a stored initial base position as a control base position of the stroke detector to control the actuator based on the detection value of the stroke detector, and each time the input member is moved backward beyond the control base position, the controller updates the control base position of the stroke detector to a position of the input member at that time.

### BACKGROUND OF THE INVENTION

The present invention relates to a brake apparatus for a vehicle.

Conventionally, there has been known a brake apparatus which drives an actuator according to a detected amount of a brake operation to generate a hydraulic pressure in a master cylinder, thereby braking a vehicle (for example, Japanese Patent Application Public Disclosure No. 2007-112426).

### SUMMARY OF THE INVENTION

Sometimes, the above-mentioned conventional brake apparatus should start and operate even when adjustments of various kinds of sensors have not been completed yet. Such an operating state may lead to generation of an unintended brake force, i.e., a brake drag. An object of the present invention is to provide a brake apparatus capable of preventing generation of an unintended brake force.

To achieve the forgoing and other objects, preferably, the present invention is configured in such a manner that, when a detected amount of a brake operation is reduced to be smaller than an initial base position after a brake apparatus is started up, the brake apparatus updates a control base position to the operation amount at that time.

According to the brake apparatus of the present invention, it is possible to prevent generation of an unintended brake force.

### BRIEF DESCRIPTION OF THE DRAWINGS

FIG. 1 illustrates a brake system to which a brake apparatus according to a first embodiment is applied;

FIG. 2 is a partial cross-sectional view of the brake apparatus;

FIG. 3 is a flowchart of control performed when the system is started up;

FIG. 4 is a characteristic diagram indicating the relationship between the position of an input member and the position of a booster piston;

FIGS. 5(a) and 5(b) are time charts illustrating the detection value of a stroke sensor and the position of the booster position when the system is started up;

FIGS. 6(A) to 6(F) illustrate the positional relationship among the input member, the booster piston, and a slide shaft when the system is started up;

FIGS. 7(a) and 7(b) are time charts illustrating the positional relationship among the input member, the booster piston, and the slide shaft when the system is started up; and

FIG. 8 is a characteristic diagram indicating the relationship between the stroke of a brake pedal and a hydraulic pressure when the system is started up.

### DETAILED DESCRIPTION OF THE INVENTION

In the following, an embodiment that carries out the brake apparatus of the present invention will be described with reference to the accompanying drawings.

### First Embodiment

### Configuration of First Embodiment

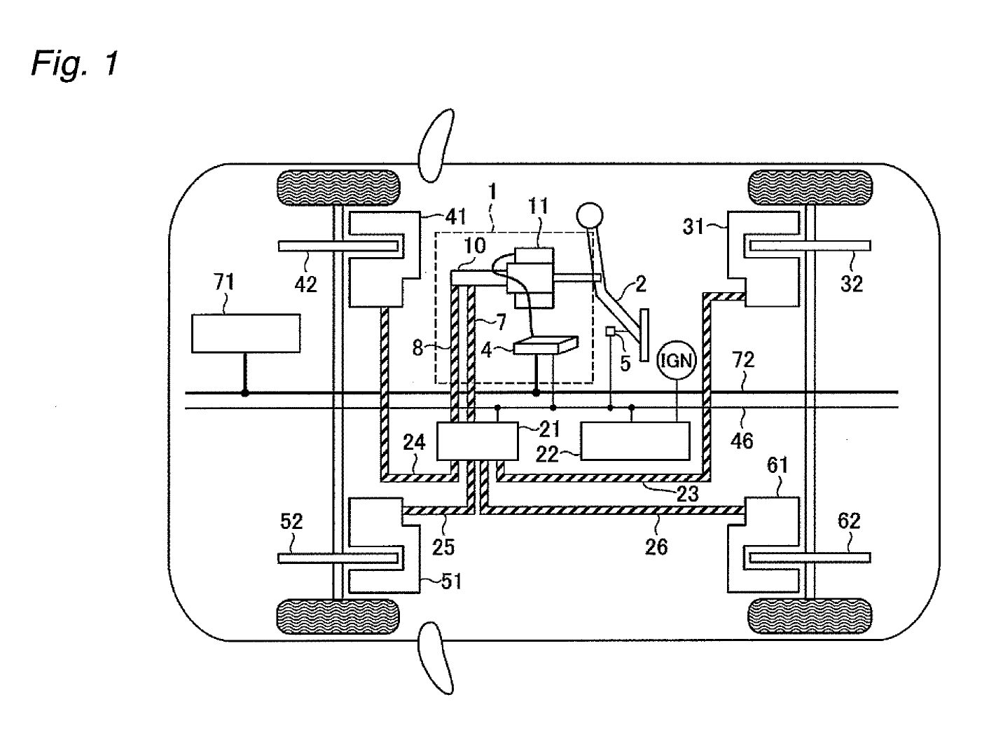

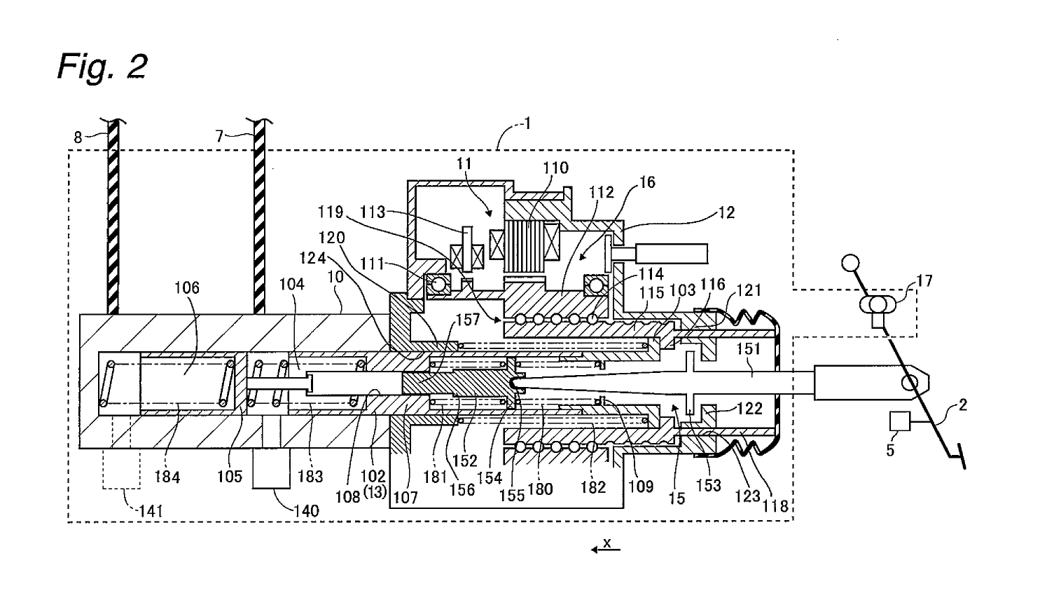

FIG. 1 illustrates a brake system of a vehicle to which a brake apparatus (hereinafter referred to as “apparatus 1”) according to a first embodiment is applied. FIG. 2 is a partial cross-sectional view of the apparatus 1. As shown in FIG. 1, the brake system includes a brake pedal 2, the apparatus 1, a hydraulic apparatus 21, a power source apparatus 71, and a vehicle control apparatus 22. The brake pedal 2 is an operation member to which a driver inputs a brake operation. The apparatus 1 is connected to the brake pedal 2, and generates a hydraulic pressure (more specifically, an oil pressure) by functioning based on a brake operation. The hydraulic apparatus 21 is connected to the apparatus 1 through two pipes 7 and 8, and distributes a hydraulic pressure (brake hydraulic pressure) P generated in the apparatus 1 to calipers (wheel cylinders) 31, 41, 51, and 61 disposed at the respective wheels of the vehicle through pipes 23 to 26. The power source apparatus 71 is, for example, a battery connected to the apparatus 1 through a power line 72 to supply power from the power source to the apparatus 1. The vehicle control apparatus 22 is connected to the apparatus 1 and the hydraulic apparatus 21 through a communication line 46, and controls operations of the apparatus 1 and the hydraulic apparatus 21. The calipers 31 to 61 press frictional materials to rotors 32 to 62 by thrust forces according to supplied hydraulic pressures, respectively, thereby generating brake forces at the respective wheels. The apparatus 1 (controller 4), the hydraulic apparatus 21, and the vehicle control apparatus 22 are connected to one another through the communication line 46, and exchange (transmit and receive) information signals among them. The communication method may be serial communication or multiplex communication such as CAN.

As shown in FIG. 2, the apparatus 1 is an electric hydraulic generation apparatus, and includes a master cylinder 10, an input member 15, an assist member 13, an actuator portion 16, a stroke sensor 17, and a controller 4. The master cylinder generates a hydraulic pressure. The input member 15 is configured to be moved forward and backward according to an operation of the brake pedal 2. The assist member 13 is disposed so as to be movable relative to the input member 15. The actuator portion 16 moves the assist member 13 forward or backward by applying an assist thrust force to the assist member 13, to generate a hydraulic pressure in the master cylinder 10. The stroke sensor 17 functions as a stroke detector configured to detect an amount (operation stroke) of a forward or backward movement of the input member 15. The controller 4 controls the actuator portion 16 based on a detection result of the stroke sensor 17, once a predetermined system start condition is satisfied to establish a controllable state. The above-mentioned input member 15, the assist member 13, and the actuator portion 16 are disposed in a case 12, and constitute an electric boosting apparatus (booster).

The controller 4 includes an inverter circuit, and controls the rotational direction and the torque of an electric motor 11 by converting DC electricity, which is received from the power source apparatus 71 through the power line 72, to AC electricity, and controlling and supplying the converted AC electricity to the electric motor 11 (actuator). In FIG. 2, the controller 4 and the case 12 are illustrated as separate structures, but may be configured as an integrated structure.

The hydraulic apparatus 21 determines a hydraulic pressure supplied to each of the calipers 32 to 62 based on the hydraulic pressure from the master cylinder 10. Further, the hydraulic apparatus 21 contains a pump for generating a hydraulic pressure, and an electromagnetic valve for controlling the hydraulic pressure as an actuator, and is provided so as to be able to control a hydraulic pressure supplied to each of the calipers 32 to 62 independently of the hydraulic pressure of the master cylinder 10. As a result, it is possible to perform the anti-lock brake control (ABS), the slide prevention control, the traction control, and other kinds of brake force control for improving the steering stability of the vehicle.

The vehicle control apparatus 22 is in charge of control for changing a running state of the vehicle (for example, the vehicle follower control and Intelligent Transport Systems (ITS)) based on information from an external recognition sensor such as a camera and a radar unit, and a navigation system. The vehicle control apparatus 22 transmits information of, for example, a required brake force, and a torque and a hydraulic pressure corresponding to the brake force as a control request through the communication line 46 to the apparatus 1, which can generate a brake hydraulic pressure for satisfying the brake force required to change the running state. Further, the vehicle control apparatus 22 is in charge of the regenerative control for converting motion energy of the vehicle to electricity. The vehicle control apparatus 22 outputs a control request for so-called the regenerative cooperative control, i.e., control of combining a regenerative brake force generated when a vehicle drive actuator is caused to function as a generator to regenerate electricity to the power source apparatus (battery) 7 while a driver is slowing down the vehicle, and a hydraulic brake force derived from a hydraulic pressure supplied to each of the calipers 32 to 62. Therefore, the vehicle control apparatus 22 transmits information of, for example, a regenerative amount, and a regenerative brake amount, a torque, and a hydraulic pressure corresponding to the regenerative amount to the apparatus 1 as a control request through the communication line 46, whereby the controller 4 of the apparatus 1 can control the electric motor 11 (actuator) so that the brake amount corresponding to the hydraulic brake force is reduced by a brake amount corresponding to the regenerative brake force.

As shown in FIG. 2, the input member 15 includes an input rod 151 and an input piston 152. The input rod 151 is moved forward and backward according to an operation of the brake pedal 2. The input piston 152 is moved forward and backward according to a movement of the input rod 151. The input member 15 advances so as to be moved away (as viewed from a driver) when the brake pedal 2 is pressed down, and retracts so as to be moved closer (as viewed from a driver) when the brake pedal 2 is returned (released). For convenience of description, the following definition is provided. An x axis is set along the direction in which the input member 15 is moved, assuming that the positive direction of the x-axis represents the direction of a forward movement, while the negative direction of the x-axis represents the direction of a backward movement. As the input member 15 is moved forward, the position Si of the input member 15 has an increased value. As the input member is moved backward, the position Si has a reduced value.

The end of the input rod 151 in the x-axis negative direction is connected to the brake pedal 2 so as to be rotatable relative to the brake pedal 2. A flange-like stopper portion 153, which radially outwardly extends, is disposed at an intermediate position of the input rod 151 in the x-axis direction. The portion of the input rod 151 in the x-axis positive direction beyond the stopper portion 153 is tapered, and the end of the input rod 151 in the x-axis positive direction is fitted in a recess 155 formed at the end of the input piston 152 in the x-axis negative direction to be connected to the input piston 152. The input piston 152 is formed into a stepped cylindrical shape, and a flange 154 is formed at the end of the input piston 152 in the x-axis negative direction as a radially outwardly extending spring retainer (retainer). A substantially cylindrical stopper portion 156 is formed at the portion of the input rod 52 in the x-axis positive direction beyond the flange 154. A substantially cylindrical pressure receiving portion 157 smaller than the stopper portion 156 in diameter is formed at the portion of the input rode 52 in the x-axis positive direction beyond the stopper portion 156.

The actuator portion 16 includes an electric motor 11 (a stator 110 and a rotator 112), and a ball and screw mechanism 119. The electric motor 11 is an electrical portion of the actuator. The ball and screw mechanism 119 functions as a rotation/linear motion conversion mechanism for converting a motion of the electric motor 11 (the rotator 112) and transmitting a linear motion thrust force to the assist member 13. The electric motor 11 and the ball and screw mechanism 119 are coaxially contained, together with a booster piston 102 and springs 180, 181, and 182, in the case 2 which is a housing for holding these members. The booster piston 102 functions as the assist member 13 configured to be driven by the electric motor 11 to generate a hydraulic pressure for assisting a brake operation force of a driver. The springs 180, 181, and 182 function as biasing units configured to bias the input member 15 and the booster piston 102 to adjust the positions of them in the x-axis direction. The electric motor 11 and the ball and screw mechanism 119 may not be contained coaxially in the case 12, and may be disposed in the case 12 around a different axis from the axis of the assist member 13. In this case, the electric motor 11 and the ball and screw mechanism 119 may not be contained in the case 12.

A substantially cylindrical support portion 120 is formed at the front of the case 12 in the x-axis positive direction so as to be opened to the interior of the case 12 in a protruding manner for guiding and supporting the booster piston 102. The portion of the case 12 in the x-axis negative direction has a stepped shape, and includes a first stopper portion 121 relatively large in inner diameter, and a second stopper portion 122 smaller than the first stopper portion 121 in inner diameter and opened to the outside of the case 12 (in a boot). The first stopper portion 121 and the second stopper portion 122 are sized so that the inner diameter of the first stopper portion 121 is larger than the outer diameter of the stopper portion 153 of the input rod 151, while the inner diameter of the second stopper portion 122 is smaller than the outer diameter of the stopper portion 153. The stopper portion 153 is disposed so as to be able to abut against and be separated from the second stopper portion 122, whereby the second stopper portion 122 functions to limit a movement of the input rod 151 in the x-axis negative direction. The first stopper portion 121 of the case 12 includes a hole 123 formed therethrough in the x-axis direction for guiding and supporting a slide shaft 115.

The electric motor 11 is a permanent magnet type synchronous motor driven by three-phase AC power. The electric motor 11 may be embodied by an induction motor, a DC brushless motor, and another type of motor, and is not especially limited to a permanent magnet type synchronous motor. The stator 110 of the electric motor 11 is installed in the case 12, and generates a rotational magnetic field in response to electricity supplied from the controller 4. The rotator 112 includes a permanent magnet, and is rotatably supported inside the stator 110 through a bearing 111 disposed in the case 12. The rotator 112 is driven to be rotated by the rotational magnetic field generated by the stator 110 to generate a torque.

The ball and screw mechanism 119 includes the rotator 112, and the slide shaft 115 disposed inside the rotator 112. The rotator 112 has a hollow interior, and includes grooves, which are engaged with balls 114, on the inner circumferential surface thereof. The slide shaft 115 includes grooves, which are engaged with a plurality of balls 114, on the outer circumferential surface thereof. A rotation (torque) of the rotator 112 is transmitted to the slide shaft 115 through the plurality of balls 114, thereby moving the slide shaft 115 in the x-axis direction. The slide shaft 115 is formed into a substantially cylindrical shape, and includes a radially inwardly extending flange-like stopper portion 116 at the portion of the slide shaft 115 in the x-axis negative direction (the portion of the slide shaft 115 contained in the case 12). The slide shaft 115 includes a supported portion 118 extending from the stopper portion 116 in the x-axis negative direction. The supported portion 118 extends through the through-hole 123 formed at the first stopper portion 121 of the case 12 so as to be relatively movable. The stopper portion 116 (the surface of the stopper portion 116 in the x-axis negative direction) is configured to be able to abut against and be separated from the first stopper portion 121 of the case 12, whereby the first stopper portion 121 limits a movement of the slide shaft 115 in the x-axis negative direction.

The booster piston 102 as the assist member 13 is formed into a substantially cylindrical shape, and is disposed through a through-hole 124 formed at the support portion 120 at the front of the case 12 in the x-axis positive direction, so as to be movable relative to the case 12. A flange-like stopper portion 103, which extends radially outwardly, is formed at the end of the booster piston 102 in the x-axis negative direction. The stopper portion 103 is disposed so as to be movable relative to the slide shaft 115 in the x-axis direction along the inner circumferential surface of the slide shaft 115. The stopper portion 103 (the surface of the stopper portion 103 in the x-axis negative direction) is disposed so as to be able to abut against and be separated from the stopper portion 116 of the slide shaft 115. The booster piston 102 includes a wall 107 formed on the inner circumferential surface thereof at a relatively front position of the booster piston 102 in the x-axis positive direction. A hole 108, which is smaller than the stopper portion 156 of the input piston 152 in diameter, is formed through the wall 107 in the x-axis direction. The pressure receiving portion 157 of the input piston 152 is relatively-movably and liquid-tightly disposed in the through-hole 108. The pressure receiving portion 157 of the input piston 152 is configured in such a manner that the pressure-receiving area in a primary hydraulic chamber 104 of the master cylinder 10 is sufficiently smaller than the pressure-receiving area of the booster piston 102. A flange 109 as a spring retainer (retainer), which radially inwardly extends, is formed on the inner circumferential surface of the portion of the booster piston 102 in the x-axis negative direction relative to the wall 107. The input piston 152, i.e., the input member 15 may not have the pressure receiving portion 157 facing the primary hydraulic chamber 104 of the master cylinder 10. The input member 15 may be any input member configured to be movable relative to the assist member 13, such as an input member for a so-called brake-by-wire system that does not transmit a pressing force to the piston of the master cylinder 10 except when a failure occurs at the actuator portion 16.

The spring 182, which biases the booster piston 102 in the x-axis negative direction, is disposed between the support portion 120 (the end of the support portion 120 in the x-axis negative direction) of the case 12 and the stopper portion 103 (the surface of the stopper portion 103 in the x-axis positive direction) of the booster piston 102. The spring 182 functions as a set load for returning the booster piston 102 to an initial position (limit position Sb0), and moves the stopper portion 103 of the booster piston 102, and the stopper portion 116 of the slide shaft 115 in abutment with the stopper portion 103 to reach, for example, the first stopper portion 121 of the case 12, when the electric motor 11 does not generate a torque. Further, the spring 181 is disposed between the wall 107 (the end of the wall 107 in the x-axis negative direction) of the booster piston 102 and the flange 154 (the surface of the flange 154 in the x-axis positive direction) of the input piston 152. The spring 180 is disposed between the flange 154 (the surface of the flange 154 in the x-axis negative direction) of the input piston 152 and the flange 109 (the surface of the flange 109 in the x-axis positive direction) of the booster piston 102. The springs 180 and 181 exert biasing forces to return the input piston 152 (the input member 15) to the neutral position relative to the booster piston 102, and functions as a set load for returning the input member 15 to an initial position (limit position Si0) when the booster piston 102 is located at the initial position (limit position Sb0). The springs 180 and 181 are not necessarily provided. Either one of them may be omitted, or both of them may be omitted.

The master cylinder 10 is connected to the case 12. The master cylinder 10 is configured as a so-called tandem-type master cylinder including the primary hydraulic chamber 104 and a secondary hydraulic chamber 106 arranged in tandem as pressurizing chambers for generating a hydraulic pressure. The primary hydraulic chamber 104 is pressurized by the booster piston 102 (and the input piston 152), and the secondary hydraulic chamber 106 is pressurized by a bottomed cylindrical secondary piston 105. The pipe 7 is in communication with the primary hydraulic chamber 104, and the pipe 8 is in communication with the secondary hydraulic chamber 106. Further, a reservoir reserving brake fluid is connected to the respective hydraulic chambers 104 and 106. The communication between the primary hydraulic chamber 104 and the reservoir is broken by a movement of the booster piston 102 from an initial position (a waiting position Sbt when the brake is released) in the x-axis positive direction by a predetermined distance. Similarly, the communication between the secondary hydraulic chamber 106 and the reservoir is broken by a forward movement of the secondary piston 105. Further, a return spring 183, which biases the booster piston 102 toward the initial position thereof, is disposed in the primary hydraulic chamber 104 between the surface of the bottom of the secondary piston 105 in the x-axis negative direction (the end of the secondary piston 105 in the x-axis negative direction), and the surface (pressure-receiving surface) of the wall 107 of the booster piston 102 in the x-axis positive direction. A return spring 184, which biases the secondary piston 105 toward the initial position thereof, is disposed in the secondary hydraulic chamber 106 between the end (bottom) of the master cylinder 10 in the x-axis positive direction, and the surface (pressure-receiving surface) of the bottom of the secondary piston 105 in the x-axis positive direction.

The booster piston 102 and the input piston 152 function as a primary piston of the master cylinder 10, and a hydraulic pressure (master cylinder pressure) P in the primary hydraulic chamber 104 is increased by movements of the pistons 102 and 152 in the x-axis positive direction. That is, a movement of the input piston 152 in the x-axis positive direction causes the volume of the primary hydraulic chamber 104 to be compressed, thereby generating the master cylinder pressure P. Further, application of an assist thrust force to the booster piston 102, which is an assist member, to move the booster piston 102 in the x-axis positive direction can further generate the hydraulic pressure P in the master cylinder 10. More specifically, a movement of the slide shaft 115 in the x-axis positive direction with the stopper portion 116 of the slide shaft 115 in abutment with the stopper portion 103 of the booster piston 102 causes the booster piston 102 to be pushed into the primary hydraulic chamber 104 of the master cylinder 10, thereby increasing the output hydraulic pressure P in the master cylinder 10. Further, the secondary piston 105 is moved in the x-axis direction based on the hydraulic pressure in the primary hydraulic chamber 104, and is stopped at the position where the hydraulic pressure in the primary hydraulic chamber 104 and the hydraulic pressure in the secondary hydraulic chamber 106 becomes substantially equal. In this way, substantially equal hydraulic pressures P are supplied from the primary hydraulic chamber 104 and the secondary hydraulic chamber 106. Then, the operating fluid in the respective hydraulic chambers 104 and 106 pressurized by an advance of the booster piston 102 is supplied as a brake hydraulic pressure to the hydraulic apparatus 21 through the pipes 7 and 8.

The controller 4 is configured to receive signals from various sensors including a brake switch 5, the stroke sensor 17, hydraulic pressure sensors 140 and 141, and a rotational sensor 113, and receive an ON/OFF signal of an ignition switch IGN. The brake switch 5 also functions as a brake lamp switch as a pedal switch disposed on the brake pedal 2. The brake switch 5 detects whether the brake pedal 2 is operated, i.e., a start and an end of an operation from an ON/OFF switch, and outputs that information signal to the controller 4.

The stroke sensor 17 is disposed on the brake pedal 2, and detects an operation amount of the brake pedal 2 (a pressed/returned amount or a stroke amount), in other words, detects an operation stroke from an amount of a forward or backward movement of the input member 15 to output that information signal to the controller 4. More specifically, when the input member 15 is moved forward or backward along the x-axis direction according to a driver's operation of the brake pedal 2, the geometrical relationship between the brake pedal 2 and the input rod 151 is fixed. Therefore, the position of the input member 15, or an amount of a forward or backward movement of the input member 15 can be detected based on a displacement of an output value of the stroke sensor 17 from a predetermined control base position (zero position) S*. Therefore, the apparatus 1 processes the detection value S of the stroke sensor 17 as the detection position of the input member 15 or an amount of a movement of the input member 15 in the x-axis direction. The stroke sensor 17 may be provided as a member integrally installed to the apparatus 1 (case 12) or a member contained within the apparatus 1, instead of being disposed on the brake pedal 2. An amount of a forward or backward movement of the input member 15 may be directly detected, instead of being detected based on the output value of the stroke sensor 17. The stroke sensor 17 may be a rotational sensor or a linear motion sensor. Further, the stroke sensor 17 may be embodied by, for example, a potentiometer with use of a variable resistor, or a rotary encoder. Further, the stoke sensor 17 may employ the method of detecting a position by an optical pick-up based on a rotational slit, or the method of detecting a magnetic change with use of a magnetic element.

The hydraulic pressure sensor 140 measures a hydraulic pressure in the primary hydraulic chamber 104, and the hydraulic pressure sensor 141 measures a hydraulic pressure in the secondary hydraulic chamber 106. The hydraulic pressure sensors 140 and 141 each output an information signal indicating a measured hydraulic pressure to the controller 4. Since the hydraulic chambers 104 and 106 have substantially equal pressures, one of the hydraulic pressure sensors 140 and 141 may be omitted, or both sensors 140 and 141 may be disposed in only one of the primary hydraulic chamber 104 and the secondary hydraulic chamber 106. The rotational sensor 113 is disposed at an outer circumferential position of the rotator 112. The rotational sensor 113 detects the position (the rotational angle or the rotational phase) of the magnetic pole of the rotator 112, and outputs that information signal to the controller 4. An amount of a movement of the slide shaft 115 in the x-axis direction can be calculated based on the output value of the rotational sensor 113, i.e. the rotational amount of the rotator 112 from a predetermined base position (zero position). The rotational sensor 113 may be embodied by an optical or magnetic encoder or resolver.

The controller 4 includes the inverter circuit which generates three-phase AC current for driving the electric motor 11 by a switching element. The inverter circuit includes a current sensor constituted by, for example, a hole device or shunt resistance. The information detected by the rotational sensor 113 and the current sensor is used for control of current supplied to the stator 110. In other words, the controller 114 controls the rotational position and speed of the rotator 112, i.e., the positions and speeds of the slide shaft 115 and the booster piston 102, based on the above-mentioned information. The controller 4 calculates the target position of the booster piston 102 based on the detection value of the stroke sensor 17, and controls the operation of the electric motor 11 based on the detection value of, for example, the rotational sensor 113 so that the actual position Sb of the booster piston 102 reaches the target position. As a result, the hydraulic pressure P can be generated in the master cylinder 10 according to a driver's brake pedal operation.

More specifically, when the input piston 152 is moved forward by an operation of the brake pedal 2 (the input rod 151), the rotator 112 of the electric motor 11 is rotated by control current from the controller 4. This rotation causes the booster piston 102 to follow the input piston 152 to be moved forward through the slide shaft 115 of the ball and screw mechanism 119, resulting in pressurization of the primary hydraulic chamber 104 and the secondary hydraulic chamber 106. In this way, an assist force is applied by the electric motor 11 according to the operation of the brake pedal 2, performing the boosting control. At this time, the pressure in the primary hydraulic chamber 104 is fed back to the input rod 151 (the brake pedal 2) through the input piston 152. Further, brake control such as the brake assist control, the regenerative cooperative control, and the vehicle follower control can be realized by appropriately controlling the rotation of the electric motor 11 by the controller 4 based on the detection values of the various kinds of sensors. The regenerative cooperative control is control of reducing a brake force derived from a hydraulic pressure by an amount corresponding to a brake force derived from regeneration, by controlling the rotation of the electric motor 11 in the direction returning the booster piston 102 in the x-axis negative direction. Since the input piston 152 and the booster piston 102 are configured to be movable relative to each other, a desired boosting ratio can be generated during the above-described brake control. That is, the brake control generates, in the hydraulic chambers 104 and 106, the hydraulic pressure boosted at a boosting ratio according to the ratio of the pressure-receiving areas of the input piston 152 and the booster piston 102, and/or a booting ratio according to the relative displacement amount Δx between the input piston 152 and the booster piston 102. The boosting ratio can be changed by changing the relative displacement amount Δx between the input piston 152 and the booster piston 102, which is generated in response to a movement of the input piston 152. In this case, gradually increasing the relative displacement amount Δx for a movement amount of the input piston 152 increases the rate of the rise of the hydraulic pressure in response to a pressing stroke of the brake pedal 2. In other words, it is possible to realize control (advance control) capable of providing a so-called short stroke feeling to a driver. Further, control of maintaining a constant boosting ratio (equally displacing control) may be performed by setting a constant amount, for example, zero as the relative displacement amount Δx between the input piston 152 and the booster piston 102 in response to a movement of the input piston 152.

Now, the positional relationship between the booster piston 102 (the assist member 13) and the input member 15 when the brake system is in operation will be described. When the brake pedal 2 is not pressed, the system is not started up, and power is not supplied to the electric motor 11 (when the system is stopped and the pedal is not operated), the booster piston 102 is pushed in the x-axis negative direction by the biasing force of the sprint 182. Receiving this biasing force, the stopper portion 103 of the booster piston 102 is in abutment with the stopper portion 116 of the slide shaft 115, and the stopper portion 116 of the slide shaft 115 is in abutment with the first stopper portion 121 of the case 12, thereby preventing a further movement of the booster piston 102 in the x-axis negative direction. The position of the booster piston 102 in this state is set as a limit position Sb0, and the position of the slide shaft 115 in this state is set as a limit position Sm0. Further, in this state, since the brake pedal 2 is not pressed, the input member 15 is located at the neutral position relative to the booster piston 102 by the set loads of the springs 108 and 181. In other words, the resultant vector of the biasing forces of the springs 180 and 181 does not act on the input member 15 in neither the x-axis positive direction nor the x-axis negative direction, and therefore the input piston 152 is maintained at the neutral position relative to the booster piston 102. The neutral position of the input member 15 when the booster piston 102 is located at the limit position Sb0 is set as a limit position Si0 of the input member 15. When the input member 15 is located at the limit position Si0, the stopper portion 153 of the input rod 151 may abut against the second stopper portion 122 of the case 12 to prevent a further movement of the input member 15 in the x-axis negative direction.

On the other hand, when the brake pedal 2 is not pressed, yet the ignition switch IGN of the vehicle is turned on so that the system is started up and power can be supplied to the electric motor 11 (when the system is started up and the pedal is not operated), the booster piston 102 is controlled to wait at a predetermined waiting position Sbt. Preferably, the waiting position Sbt is a position with some extra enabling the booster piston 102 to be moved in the x-axis negative direction to realize execution of the regenerative cooperative control. When the booster piston 102 is located at the waiting position Sbt and the input piston 15 is located at the neutral position relative to the booster piston 102 by the set loads of the springs 180 and 181, this position is set as a waiting position Sit of the input member 15. While the system is in operation, the control base position S* of the stroke sensor 17 is set to this waiting position Sit, and the position Sb of the booster piston 102 is controlled based on the position Si of the input member 15 detected based on this control base position S*. Therefore, when the control base position S* of the stroke sensor 17 coincides with the waiting position Sit, controlling the electric motor 11 (the slide shaft 115) so that the stroke sensor 17 outputs zero as the detection value S results in the booster piston 102 located at the waiting position Sbt. In other words, when the control base position S* does not coincides with the waiting position Sit, controlling the electric motor 11 (the slide shaft 115) so that the stroke sensor 17 outputs zero as the detection value S results in the booster piston 102 waiting at a position offset from the waiting position Sbt.

When the brake pedal 2 is pressed in the above-described state, the electric motor 11 is driven so that the booster piston 102 is controlled to be moved from the waiting position Sbt in the x-axis positive direction according to the detection value S of the stroke sensor 17. At this time, when the stopper portion 116 of the slide shaft 115 does not abut against the first stopper portion 121 of the case 12, the rotational position of the rotator 112, the position of the slide shaft 115, and the position of the booster piston 102 are in a predetermined relationship, and can be handled as the same information. Moving the booster piston 102 by the same amount as the detection value S of the stroke sensor 17 causes the relative positions of the input member 15 and the booster piston 102 to be maintained at the neutral positions, thereby providing a fixed boosting ratio. Increasing or reducing the movement amount of the booster piston 102 compared to the detection value S of the stroke sensor 17 provides a changed boosting ratio. For example, relatively increasing the movement amount of the booster piston 102 realizes, for example, the brake assist control, while relatively reducing the movement amount of the booster piston 102 realizes, for example, the regenerative cooperative control.

In the present embodiment, even while the ignition switch ING is turned off, execution of a brake operation can start up the system so that power is supplied to the electric motor 11 to operate the booster piston 102, thereby generating a brake hydraulic pressure. The details of this control will be described later.

When the electric motor 11 cannot be driven due to, for example, a system failure, the system is set into such a state that the electric motor 11 cannot cause a movement of the slide shaft 115, and the boosting effect cannot be provided with use of the electric motor 11. In this case, upon a driver's operation of the brake pedal 2 (the input rod 151), the thrust force transmitted to the input piston 152 is transmitted to the booster piston 102 via the spring 181 and the stopper portion 156 of the input piston 152, thereby moving the booster piston 102. Therefore, the stopper portion 116 of the slide shaft 115 and the stopper portion 103 of the booster piston 102 are separated from each other, resulting in generation of a relative movement therebetween. In this way, an operation of the brake pedal 2 with a predetermined pressing force can generate hydraulic pressures in the hydraulic chambers 104 and 106 enough to ensure a minimum required brake force.

The controller 4 includes an EEPROM, which is a semiconductor storage apparatus which data can be electrically deleted from or written to. The EEPROM is configured so as to allow storage or update of the initial value of the control base position (zero position) S* of the stroke sensor 17, i.e., the initial base position, and constitutes an initial base position storage unit. The stored initial base position is read out at appropriate timing, and is used in detection of the stroke sensor 17.

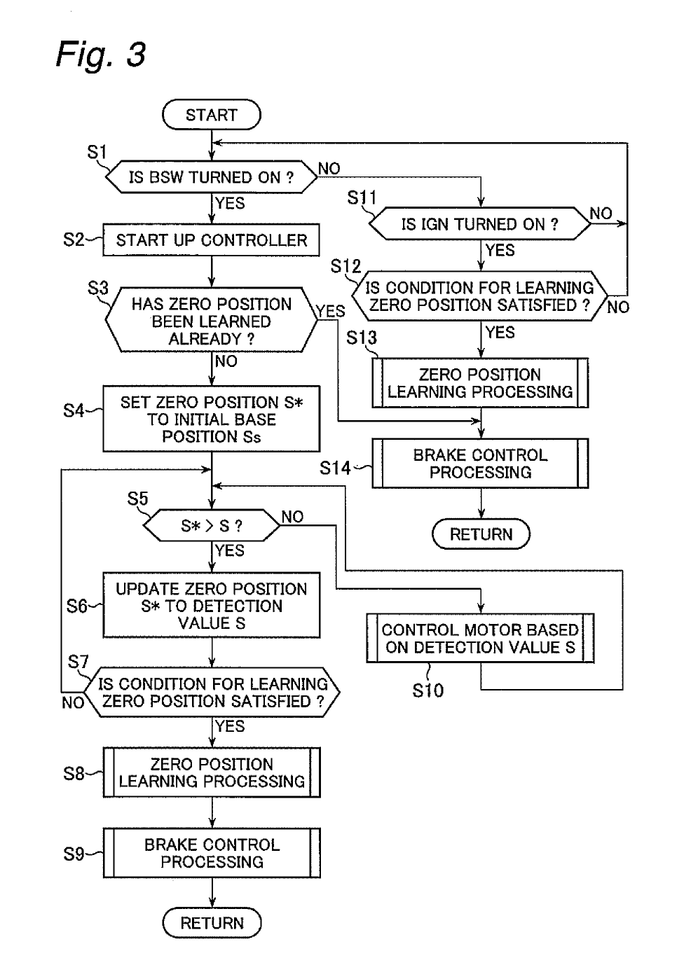

FIG. 3 illustrates an example of a control flow performed by the controller 4 when the system is started up by a driver's brake operation (more specifically, turning on the brake switch 5) while the ignition switch ING is turned off. In step S1, if the detection value of the brake switch 5, which indicates whether the brake pedal 2 is operated, is ON (the brake pedal 2 is operated), the processing proceeds to step S2. If the detection value of the brake switch 5 is OFF (the brake pedal is not operated), the processing proceeds to step S11. In step S2, the controller 4 is started up. After that, the processing proceeds to step S3. In step S3, the controller 4 determines whether the control base position (zero position) S* of the stroke sensor 17 has been already learned. If the control base position S* has been already learned, the processing proceeds to step S14 in which normal brake control is carried out. If the control base position S* has not been learned yet, the processing proceeds to step S4. In step S4, the controller 4 sets the control base position S* to an initial base position Ss (=Ss0+α) which is a value larger by a predetermined width a than an initial base position Ss0 stored in the EEPROM in advance. Then, the processing proceeds to step S5. In step S5, the controller 4 obtains the detection value S of the stroke sensor 17 based on the control base position S*, and determines whether this detection value S is smaller than the control base position S*. If the detection value S is smaller than the control base position S*, the processing proceeds to step S6 in which the controller 4 updates the control base position S* (zero position). On the other hand, if the detection value S is equal to or larger than the control base position S*(zero position), the processing proceeds to step S10, since the controller 4 does not have to update the control base position S* (zero position). In step S6, the controller 4 sets the detection value S of step S5 as the new control base position S* (zero position) (updates the control base position S* to the detection value S of step S5), and then processing proceeds to step S7. In step S7, the controller 4 determines whether a condition for learning the control base position S* is satisfied. In the present exemplary embodiment, the controller 4 determines whether the state that the brake pedal 2 is not pressed continues for a predetermined time. The details of this learning condition will be described later. If the learning condition is satisfied, the processing proceeds to step S8. If the learning condition is not satisfied, the processing returns to step S5. In step S8, the controller 4 performs the processing for leaning the control base position S*, which will be described in detail later. After that, the processing proceeds to step S9. In step S9, the controller 4 obtains the detection value S of the stroke sensor 17 based on the learned control base position S*, and controls the electric motor 11 (brake control) with use of this detection value S. In step S10, since the detection value S of step S5 is equal to or larger than the control base position S*, the controller 4 performs brake control with use of this detection value S. More specifically, the controller 4 controls the electric motor 11 so as to perform so-called equally-displacing control by moving the booster piston 102 forward by the same amount as the detection value S. After that, the processing returns to step S5. In step S11, if the ignition switch ING is turned on, the controller 4 is started up. Then, the processing proceeds to step S12. If the ignition switch ING is turned off, the processing returns to step S1. In step S12, the controller 4 determines whether the condition for leaning the control base position S* is satisfied in a similar manner to step S7. If the learning condition is satisfied, the processing proceeds to step S13. If the learning condition is not satisfied, the processing returns to step S1. In step S13, the controller 4 performs the processing for learning the control base position S* in a similar manner to step S8. Then, the processing proceeds to step S14. In step S14, the controller 4 obtains the detection value S of the stroke sensor 17 based on the learned control base position S*, in a similar manner to step S9, and performs brake control with use of this detection value S.

In this way, the controller 4 is started up to be set in a controllable state when the brake switch 5 inputs a detection signal indicating that a brake operation is performed, even while the ignition is in an OFF state. As a result, the brake system is started up (S1→S2). When the controller 4 is in a controllable state and does not yet learn the control base position S* (since before that), the controller 4 sets the pre-stored initial base position Ss (=Ss0+α) as the control base position S* of the stroke sensor (S4). Then, the controller 4 controls the electric motor 11 based on the detection value S of the stroke sensor 17 detected based on the set control base position S* (S10). More specifically, the controller 4 controls the electric motor 11 so as to move the booster piston 102 by the same amount as the detection value S, if the detection value S is equal to or larger than the initial base position Ss (S5→S10). In other words, the controller 4 moves the booster piston 102 in the x-axis direction by the same amount as the amount of the movement of the input member 15 in the x-axis direction which is detected by the stroke sensor 17. On the other hand, if the above-described detection value S is smaller than the initial base position Ss, the controller 4 controls the electric motor 11 so as not to move the booster piston forward. The initial base position Ss is set to a larger (in the advance direction) value by the predetermined width a than the value Ss0 stored when the apparatus 1 was mounted on the vehicle. For example, the value Ss0 stored when the apparatus 1 was mounted on the vehicle can be set to a position slightly displaced in the advance direction (the x-axis positive direction) from the limit position Si0 of the input member 15. Preferably, in consideration of factors that may affect the output of the stroke sensor 17 while the system is stopped (during power-off), such as a temperature drift, a mechanical backlash (a backlash of, for example, the brake pedal 2), and an error in the detection circuits, the predetermined width α is set to a value enabling absorption of an influence of an output change due to these factors.

When the controller 4 is started up by turning on the brake switch 5, the controller 4 functions in the following manner. When the detection value S of the stroke sensor 17 is equal to or smaller than the initial base position Ss from the beginning, or when the detection value S is larger than the initial base position Ss at first (therefore, the controller 4 controls the electric motor 11 so as to move the booster piston 102 by the same amount as the detection value S), but is reduced to be smaller than the initial base position Ss, i.e., each time the input member 15 is moved backward beyond the control base position S*, the controller 4 updates the control base position S* of the stroke sensor 17 to the position (the detection value S) of the input member 15 at that time (S5→S6→S7→S5). During this period, the controller 4 controls the electric motor 11 so as not move the booster piston 102 forward. When the controller 4 determines that the condition for learning the control base position S* of the stroke sensor 17 is satisfied according to the return of the brake pedal 2 to the brake release position, the controller 4 learns the control base position S* (S7→S8). In this way, the controller 4 continues updating the control base position S* until the controller 4 performs the (first) learning. If the controller 4 has already learned the control base position S* when the controller 4 is started up by turning on the brake switch 5, the controller 4 controls the booster piston 102 based on the detection value S detected based on this control base position S* (S3→S14). Further, when the controller 4 is started up in a normal manner by tuning on the ignition switch ING, the controller 4 learns the control base position S* once the learning condition is satisfied, and controls the booster piston 102 based on this control base position S* (S11→S12→S13). Further, when the controller 4 is started up in a normal manner by turning on the ignition switch ING, if the controller 4 has not yet learned the control base position S*, the controller 4 functions in the following manner. That is, each time the detection value S is reduced to be smaller than the initial base position Ss, i.e., each time the input member 15 is moved backward beyond the control base position S*, the controller 4 updates the control base position S* of the stroke sensor 17 to the position (detection value S)) of the input member 15 at that time (S5→S6→S7→S5).

Now, a description will be given of the processing for learning the control base position S* of the stroke sensor 17 performed in steps S8 and S13 in the above-described control shown in FIG. 3. The controller 4 learns the control base position S* based on the output of the stroke sensor 17 when the booster piston 102 reaches the limit position Sb0 beyond which the booster piston 102 cannot be further moved backward (in the x-axis negative direction), and uses this output value with a predetermined value β added thereto as a learned value. This predetermined value β is such an extra that the booster piston 102 can have a stroke so as to be able to reduce a hydraulic brake force corresponding to a regenerative brake operation. The controller 4 determines in steps S 7 and S12 whether the learning condition is satisfied based on whether the brake pedal 2 is not pressed and the controller 4 does not receive a control request through the communication line 46. Further, while the hydraulic apparatus 21 is controlling the hydraulic pressure, this may causes a change in the hydraulic pressure P in the master cylinder 10, and the positions of the input member 15 and the booster piston 102. Therefore, the controller 4 learns the control base position S*, when the hydraulic apparatus 21 does not apply the hydraulic pressure control to the calipers (wheel cylinders) 31, 41, 51, and 61.

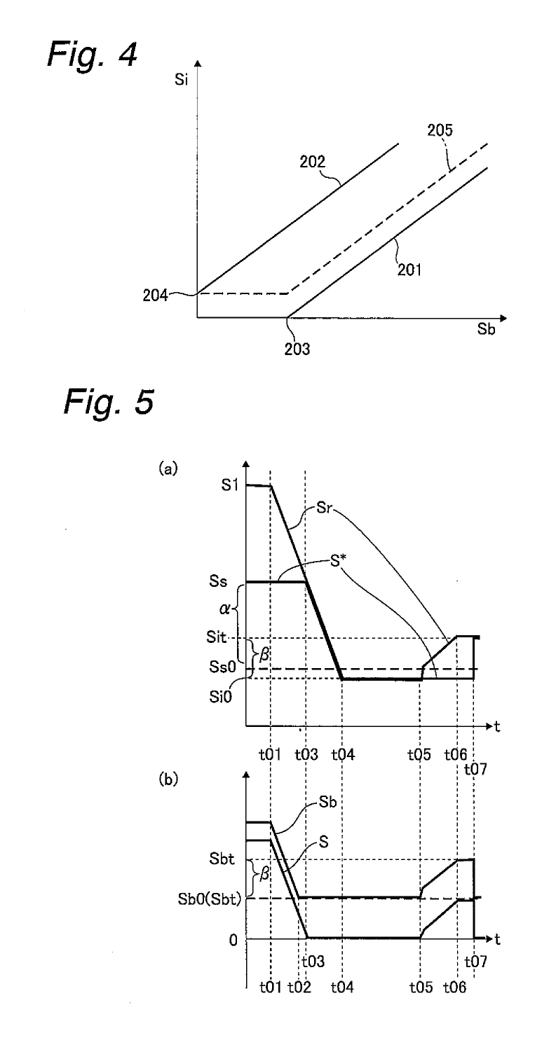

Whether the brake pedal 2 is pressed as mentioned above can be more accurately determined by slightly moving the booster piston 102. Now, the principle thereof will be described with reference to FIG. 4. FIG. 4 is a characteristic diagram illustrating the relationship between the position Si of the input member 15 and the position Sb of the booster piston 102 when the booster piston 102 is slightly moved in the x-axis positive direction. When a driver does not operate the brake pedal 2 and the brake control is completely stopped, a rotational torque is not generated at the rotator 112, and a thrust force is not generated at the input member 15 by the brake pedal 2. Therefore, the positional relationship between the input member 15 and the booster piston 102 is determined by the springs 180 and 181. When the brake pedal 2 is slightly pressed in this state, the input member 15 is slightly moved in the x-axis positive direction, the spring 180 is slightly extended, and the sprig 181 is slightly compressed. When the operation of pressing the brake pedal 2 is removed, the input member 15 is returned to the original position by the springs 180 and 181.

A characteristic 201 indicates the characteristic when the brake pedal 2 is not pressed. When the electric booster 11 is driven to quietly move the booster piston 102 in the x-axis positive direction, the spring 181 is extended little by little while the spring 180 is compressed little by little. Despite an increase in the pressing force of the spring 180 acting on the input member 15, the input member 15 remains at that position without being moved due to an influence of, for example, a static frictional force until the booster piston 102 reaches a position 203. Once the booster piston 102 is moved beyond the position 203 in the x-axis positive direction, the input member 15 starts to be moved. On the other hand, a characteristic 202 indicates the characteristic when the brake pedal 2 is slightly pressed in advance. Since the brake pedal 2 is slightly pressed, the input member 15 has been already moved to a position 204, and the spring 180 is slightly extended while the spring 181 is slightly compressed. When the electric motor 11 is driven to quietly move the booster piston 102 in the x-axis positive direction in this state, the input member 15 is immediately moved, following this movement of the booster piston 102. Further, a characteristic 205 represented by a broken line indicates the characteristic when the output of the stroke sensor 17 is subject to, for example, a drift. Due to the influence of, for example, a drift, the output of the stroke sensor 17 is similar to that when the brake pedal 2 is pressed (for example, a position near the position 204). However, since the brake pedal 2 is not pressed, the spring 180 and the spring 181 applies substantially equal biasing forces to the input member 15. When the electric motor 11 is driven to quietly move the booster piston 102 in the x-axis positive direction, the spring 181 is extended little by little while the spring 180 is compressed little by lithe, increasing the pressing force of the spring 180 applied to the input member 15. Once the booster piston 102 is moved beyond the position 203, the input member 15 starts to be moved. Due to this difference between the characteristic 202 and the characteristic 205, it is possible to accurately determine whether the brake pedal 2 is pressed even if the output of the stroke sensor 17 has a slight deviation.

FIG. 5 illustrates an example of changes over time in the output value S of the stroke sensor 17 and the position Sb of the booster piston 102 (as viewed from the input member 15) when the system is started up by pressing the brake pedal 2 (turning on the brake switch 5). In FIG. 5(a), the vertical axis represents the raw value or the output value of the stroke sensor 17, i.e., the value of the angle or voltage of the stroke sensor 17, in other words, a value corresponding to the stroke amount of the brake pedal 2, the amount of a movement of the input member 15 in the x-axis direction, and the position of the input member 15.

At time t01, the brake switch 5 is turned on, the controller 4 is started up, and the control base position S* of the stroke sensor 17 is set to the initial base position Ss (=Ss0+α). Until time t01, a driver's operation amount of the brake pedal 2 (the raw value of the stroke sensor 17=the output value Sr) is constant, and is maintained at the value S1. The position of the input member 15 recognized by the controller 4, i.e., the detection value S of the stroke sensor 17 is a value based on the control base position S* (the initial base position Ss), i.e., equal to the output value Sr of the stroke sensor 17 with the value of the control base position S* subtracted therefrom. As shown in FIG. 5(a), since the operation amount of the brake pedal 2 (the output value Sr of the stroke sensor 17) is constant, the detection value S of the stroke sensor 17 is also constant, so that the position Sb of the booster piston 102 controlled based thereon is also constant as shown in FIG. 5(b). The booster piston 102 is controlled so as to be displaced by the same amount as the detection value S of the stroke sensor 17, i.e., by the same movement amount as the movement amount of the input member 15 indicated by the detection value S. In other words, the booster piston 102 is controlled under equally-displacing control so that the booster piston 102 and the input member 15 are moved by the same amount, respectively.

After time t01, as the driver's operation amount of the brake pedal 2 is reduced (the brake pedal 2 is returned), the output value Sr and the detection value S of the stroke sensor 17 are reduced as shown in FIG. 5(a), and the position Sb of the booster piston 102 controlled based on the detection value S is also reduced (moved in the x-axis negative direction) as shown in FIG. 5(b). At this time, since the initial base position Ss (=Ss0+α) is set to the position advanced from the position Ss0 by the amount α in the x-axis positive direction, the detected position of the input member 15 is a position returned by the amount α relative to the x-axis negative direction. Therefore, the position of the booster piston 102 is controlled to be maintained at the position returned by the amount α in the x-axis negative direction based on the neutral position relative to the input member 15. At time t02, the stopper portion 116 of the slide shaft 115 abuts against the first stopper portion 121 of the case 12, so that the booster piston 102 is mechanically prevented from being further moved in the x-axis negative direction (stroke Sb). Therefore, the position of the booster piston 102 is maintained at the limit position Sb0. On the other hand, the operation amount of the brake pedal 2 (the output value Sr of the stroke sensor 17) continues being reduced, so that the detection value S of the stroke sensor 17 continues being reduced.

At time t03, the output value Sr (the detection value S) of the stroke sensor 17 is reduced to the initial base position Ss (zero) set as the control base position S*. After time t03, in each control cycle, the output value Sr (the detection value S) of the stroke sensor 17 is reduced to be smaller than the control base position S* (detected value=zero) set in the previous control cycle. Therefore, the output value Sr (the detection value S) of the stroke sensor 17 is set as the control base position S* (zero position) in each cycle. In this change shown in FIGS. 5(a) and 5(b), since the operation amount of the brake pedal 2 is reduced as the time progresses (i.e., in each control cycle), the output value Sr of the stroke sensor 17 is reduced, so that the control base position S* is updated so as to be reduced as well (i.e., the control base position S* is offset from the previous value in the x-axis negative direction). Further, the detection value S of the stroke sensor 17 (in each control cycle) is maintained at approximately zero. At time t04, the springs 180 and 181 are set in a neutral state, the input piston 15 is located at the neutral position relative to the booster piston 102 (the relative displacement amount Δx therebetween becomes zero), and the input member 15 reaches the limit position Si0. In other words, the stroke amount of the brake pedal 2 becomes zero. The control base position S* is set to the limit position Si0.

At time t05, the learning condition is satisfied. In other words, the controller 4 confirms that, for example, the brake pedal 2 is not pressed during time t04 to time t05. Therefore, from time t05 until time 7, the controller 4 learns the control base position S* of the stroke sensor 17. First, while the controller 4 sets the control base position S* to the limit position Si0, the controller 4 gradually moves the input member 15 from the limit position Si0 in the x-axis positive direction by the predetermined distance β by moving the booster piston 102 in the x-axis positive direction. As shown in FIG. 5(b), the detection value S of the stroke sensor 17 is gradually increased from zero (the limit position Si0) in the x-axis positive direction by the predetermined distance β. The booster piston 102 is controlled to be displaced by the same amount as the detection value S of the stroke sensor 17 while maintaining the neutral position relative to the input member 15. Therefore, the position of the booster piston 102 is gradually increased to the waiting position Sbt apart from the limit position Sb0 in the x-axis positive direction by the predetermined distance β. At time t06, the movements of the input piston 15 and the booster piston 102 are completed. At time t07, the controller 4 resets the control base position S* by changing it to the detection value S of the stroke sensor 17, i.e., the position away from the limit position Si0 in the x-axis positive direction by the predetermined distance β. The detection value S of the stroke sensor 17 detected based on this reset (learned) control base position S* becomes zero.

After that, until next learning is carried out, the controller 4 controls the booster piston 102 based on the detection value S of the stroke sensor 17 which is detected based on the reset control base position S*. The waiting position Sbt of the booster piston 102 is set as the position of the booster piston 102 controlled corresponding to the position of the input piston 15 when the detection value S is zero. When the brake pedal 2 is not pressed, the position of the input member 15 is moved according to the position of the booster piston 102, so that the waiting position Sit of the input member 15 is set as the position of the input member 15 when the detection value S is zero (i.e., the position away from the limit position Si0 in the x-axis positive direction by the predetermined distance β.

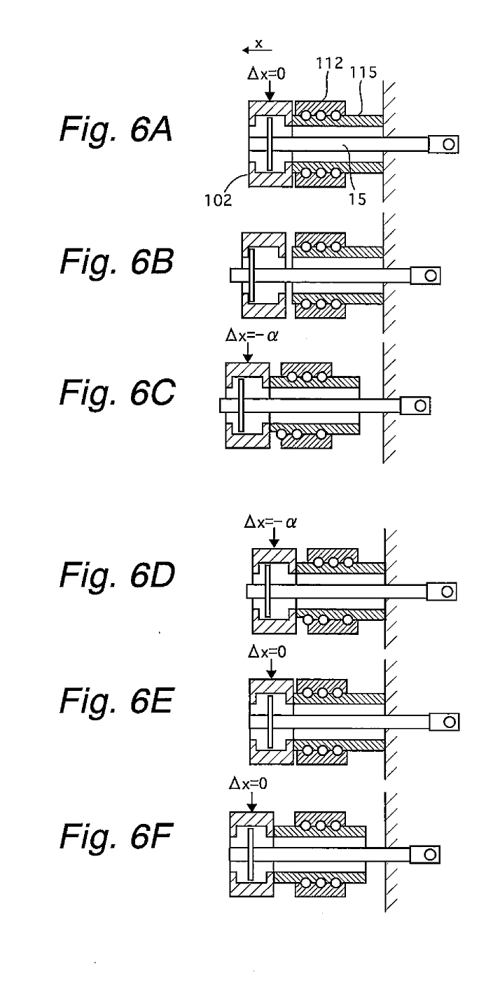

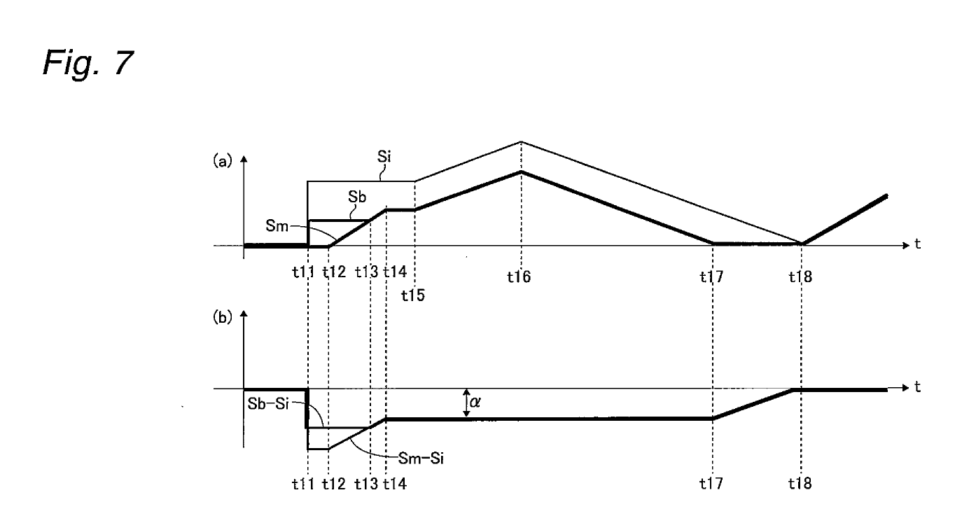

FIGS. 6A to 6F illustrate an example of the positional relationship among the input member 15, the booster piston 102, and the slide shaft 115 when the brake system is started up by turning on the brake switch 5, as operations of FIGS. 6A to 6F arranged in chronological order. FIGS. 7(a) and 7(b) illustrate a change over time in the relationship among the position Si of the input member 15, the position Sb of the booster piston 102, and the position Sm of the slide shaft 115 corresponding to the respective operations of FIGS. 6A to 6F. It should be noted that the value recognized by the controller 4 is not necessarily the same as those illustrated in FIGS. 7(a) and 7(b) due to the variability of the control base position S*. Further, for convenient of description, the springs 180 and 181 shown in FIG. 2 is omitted from the illustrations of FIGS. 6A to 6F.

FIG. 6A illustrates an operation when the brake switch 5 is turned off before a driver presses the brake pedal (corresponding to the period before time t11 shown in FIGS. 7(a) and 7(b). Since power is not supplied to the electric motor 11, the slide shaft 115 is biased in the x-axis negative direction by the force of the spring 182 through the booster piston 102, and the stopper portion 116 of the slide shaft 115 abuts against the first stopper portion 121 of the case 12, preventing the slide shaft 115 from being further moved in the x-axis negative direction. Therefore, the position Sm of the slide shaft 115 is located at the limit position Sm0, and the position Sb of the booster piston 102 is also located at the limit position Sb0. Since the brake pedal 2 is not operated, the position (Sb−Si) of the booster piston 102 relative to the input member 15 is located at the neutral position (the position where the relative displacement amount Δx becomes zero), and the position Si of the input member 15 is located at the limit position Si0 (Ss0).

FIG. 6B illustrates an operation immediately after the brake switch 5 is turned on by the driver's pressing the brake pedal 2 so that the system is started up (corresponding to time t11 to time t12 shown in FIGS. 7(a) and 7(b)). The system is started up while the input member 15 is moved in the x-axis positive direction. The thrust force transmitted from the brake pedal 2 to the input member 15 is transmitted to the booster piston 102 through the spring 181, and therefore the stopper portion 156 of the input piston 152, thereby moving the booster piston 102. On the other hand, since this is immediately before the electric motor 11 is driven, the slide shaft 115 is still located at the limit position Smo. Therefore, the booster piston 102 is separated from the slide shaft 115.

FIG. 6C illustrates an operation when the electric motor 11 is controlled so as to move the booster piston 102 by the same amount as the movement amount of the input member 15 based on the detection value S of the stroke sensor 17 (corresponding to time t12 to time t17 shown in FIGS. 7(a) and 7(b)). The control base position S* of the stroke sensor 17 is the initial base position Ss. The slide shaft 115 abuts against the booster piston 102 again to move the booster piston 102 in the x-axis positive direction (time t13 shown in FIGS. 7(a) and 7(b)). Since the detection value S of the stroke sensor 17 is detected based on the initial base position Ss (=Ss0+α), the detection value S is reduced by approximately the amount α compared to the actual movement amount of the input member 15. Therefore, the movement amount of the booster piston 102 is reduced by approximately the amount α compared to the movement amount of the input member 15. Therefore, the position (Sb−Si) of the booster piston 102 relative to the input member 15 is located at the position returned from the neutral position in the x-axis negative direction by approximately the amount α (the position where the relative displacement amount Δx becomes −α). At this time, preferably, the position (Sb−Si) of the booster piston 102 is a position allowing the booster piston 102 to be further moved therefrom in the x-axis negative direction relative to the input member 15 to reduce a hydraulic brake force corresponding to regenerative brake. When the brake pedal 2 is further pressed or returned, the slide shaft 115, the booster piston 102, and the input member 15 are moved while maintaining the positional relationship among them (time t15 to time t17 shown in FIGS. 7(a) and 7(b)).

FIG. 6D illustrates an operation when the driver releases (returns) the brake pedal 2 (corresponding to time 17 shown in FIGS. 7(a) and 7(b)). The slide shaft 115 and the booster piston 102 are prevented from being further moved in the x-axis negative direction by the first stopper portion 121, and at this time, the respective positions of the slide shaft 115 and the booster piston 102 are located at the limit positions Sm0 and Sb0. While the brake pedal 2 is returned, each time the output value Sr (the detection value S) of the stroke sensor 17 is reduced to be smaller than the initial base position Ss (zero), the control base position S* is updated to the position returned from the initial base position Ss in the x-axis negative direction according to the output value Sr (the detection value S).

FIG. 6E illustrates an operation when the brake pedal 2 is further returned (corresponding to time t17 to time t18 shown in FIGS. 7(a) and 7(b)). Since the booster piston 102 is prevented from being further moved in the x-axis negative direction, the position (Sb−Si) of the booster piston 102 relative to the input member 15 is returned to the neutral position due to the movement of the input member 15 relative to the piston 102 in the x-axis negative direction by the biasing forces of the springs 180 and 181 not shown in FIG. 6. During this period, the control base position S* continues being updated to a position returned from the initial base position Ss in the x-axis negative direction, and is finally set to the limit position Si0.

FIG. 6F illustrates an operation when the driver presses the brake pedal 2 again in such a state that the control base position S* has not been learned yet after the brake pedal 2 is almost completely returned (corresponding to the period after time t18 shown in FIGS. 7(a) and 7(b)). The controller 4 controls the electric motor 11 so as to move the booster piston 102 by the same amount as the detection value S of the stroke sensor 17 (the movement amount of the input member 15). At this time, the position (Sb−Si) of the booster piston 102 relative to the input member 15 is maintained at the neutral position (the relative displacement amount Δx=0).

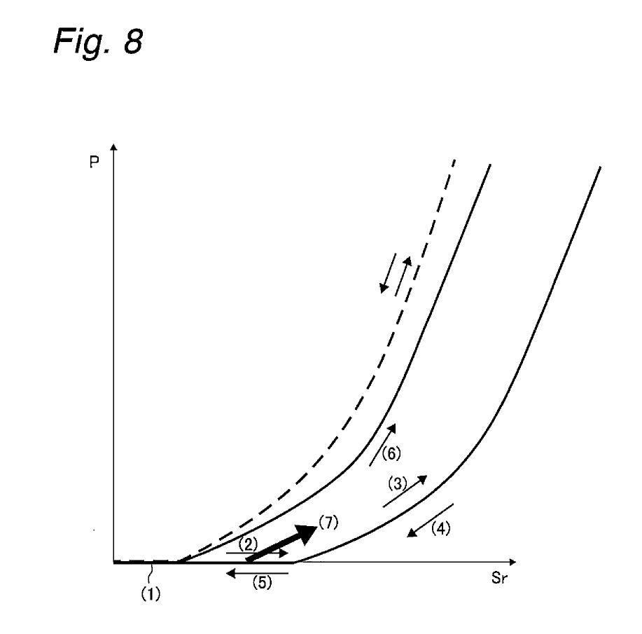

FIG. 8 illustrates the relationship between the hydraulic pressure P generated in the master cylinder 10 by an operation of the apparatus 1, and the stroke of the brake pedal 2 (the actual stroke Sr of the input member 15). The solid line represents the relationship when the system is started up by turning on the brake switch 5, on which the timing corresponding to the operations shown as FIGS. 6A to 6F are indicated by the arrows with the same number assigned thereto, respectively. For comparison, the broken line represents the relationship under the normal brake control (more specifically, under the advance control, i.e., the boosting control at an increased boosting ratio). Immediately after the system is started up by turning on the brake switch 5, the controller 4 performs brake control while setting the control base position S* to the initial base position Ss (=Ss0+α) corresponding to a stroke position further advanced compared to the control base position S*(=the waiting position Sit) under the normal control. Therefore, since the detection value S of the stroke sensor 17 is reduced in the return direction, the position and the movement amount of the booster piston 102 is controlled while the position (Sb−Si) of the booster piston 102 relative to the position of the input member 15 (the detection value S) is delayed by approximately the amount α relative to the neutral position. Therefore, as shown in the arrows (1) to (3) in FIG. 8, the hydraulic pressure P is generated according to the stroke Sr, although a rise of the hydraulic pressure P in response to the stroke Sr is delayed compared to that under the normal control.

Further, during the arrows (4) and (5), each time the output value Sr (the detection value S) of the stroke sensor 17 is reduced to be smaller than the control base position S* (zero), the control base position S* is updated to a position in the return direction (the x-axis negative direction), and is shifted from the initial base position Ss toward the control base position S* (=Sit) under the normal brake control. Therefore, when the driver presses the brake pedal 2 again in such a state that the control base position S* has not been learned yet after the brake pedal 2 is almost completely returned, at this time, the position and the movement amount of the booster piston 102 are controlled while the booster piston 102 is maintained at the neutral position relative to the input member 15, due to the elimination of the reduction a in the return direction from the detection value S of the stroke sensor 17. Therefore, as indicated by the arrow (6), the hydraulic pressure P rises in response to the stroke Sr in the same manner as the normal brake control without any delay. Even if the driver presses the brake pedal 2 again before the brake pedal 2 is completely returned after the apparatus 1 is started up by turning on the brake switch 5, the control base position S* is updated to a position in the return direction (the x-axis negative direction) from the initial base position Ss to a certain degree. In other words, since the detection value S of the stroke sensor 17 is corrected so as to approach the normal value compared to that immediately after the system is started up, the position and the movement amount of the booster piston 102 is controlled in such a state that the position of the booster piston 102 relative to the input member 15 approaches the neutral position. Therefore, as indicated by the arrow (7), the hydraulic pressure P rises in response to the stroke Sr quicker than that immediately after the system is started up.

Now, the advantageous effects of the apparatus 1 according to the present first embodiment will be described. The apparatus 1 functions as a brake apparatus which moves the assist member 13 (the booster piston 102) by driving the actuator (the electric motor 11) according to an operation amount of the brake pedal 2, and generates the hydraulic pressure P in the master cylinder 10 to thereby brake the vehicle. Even when the ignition is turned off, upon an operation of the brake pedal 2, the apparatus 1 is started up to generate the hydraulic pressure P in the master cylinder 10 by operating the booster piston 102, thereby being able to brake the vehicle. In the present first embodiment, when an operation of the brake pedal 2 is detected through the brake switch 5 which detects whether the brake pedal 2 is operated, the controller 4 is set in a controllable state. Therefore, the apparatus 1 can more accurately and quickly generate a brake force by directly detecting a driver's intention about braking. Further, the apparatus 1 can be realized with a simple structure by utilizing conventionally provided sensors without requiring an additional sensor. The controller 4 may be set in a controllable state by determining whether the brake pedal 2 is operated or detecting a driver's intention about braking based on a signal from a sensor that is not the brake switch 5.

When the apparatus 1 is started up based on a brake operation as mentioned above, since the brake pedal 2 (or the input member 15; the same shall apply hereinafter) is already operated, it is difficult to accurately set the control base position S* for use in detection of an operation amount of the brake pedal 2. More specifically, if the brake pedal 2 is not operated, it is possible to, for example, learn and correct the control base position S*. However, in the above-mentioned case, the learning is impossible since the brake pedal 2 is already operated. Therefore, a provisional control base position (the initial base position Ss) is stored before the apparatus 1 is started up, and the controller 4 controls the electric motor 11 by detecting the operation amount based on this initial base position Ss.

In the present first embodiment, the initial base position Ss is set to a large value with the extra amount α. More specifically, the initial base position Ss is set to a larger value than the value Ss0 stored when the apparatus 1 was mounted on the vehicle. Therefore, it is possible to absorb influences of factors that may affect an output of the stroke sensor 17 after the installation on the vehicle, and therefore possible to more accurately generate a brake force. In a case that the controller 4 learns the control base position, the initial base position Ss may be set to a larger value than the control base position learned and stored when the system was started up last time (for example, by the predetermined width α). Also in this case, it is possible to absorb the influences of factors that may affect an output of the stroke sensor 17 when the system is stopped (during power-off).

Another possible measure to eliminate the above-mentioned influences of factors is to set the initial original position Ss to a smaller value (in the return direction) than the stored value Ss. However, in this case, after the apparatus 1 is started up by turning on the brake switch 5, the control of the position of the booster piston 102 according to the detection value of the stroke sensor 17 (which is detected as a value advanced relative to the stored value Ss0) results in a movement of the booster piston 102 to a position advanced from the neutral position relative the input member 15. Therefore, even when the input member 15 is returned until the stopper portion 153 of the input rod 151 abuts against the second stopper portion 122 of the case 12 to prevent the input rod 151 from being further moved in the x-axis negative direction, the booster piston 102 may not be able to be returned to the limit position Sb0. On the contrary, in the present first embodiment, the initial base position Ss is set to a larger value (in the advance direction) than the stored value Ss0, and therefore can avoid such a disadvantageous situation.

However, in this case, detection of an operation amount of the brake pedal 2 based on the larger control base position S* (in the advance direction) may lead to a problem of an increase in an invalid stroke of the brake pedal 2, resulting in a reduction in the generated hydraulic pressure relative to an operation amount of the brake pedal 2. More specifically, when the control base position S* does not coincide with the control base position (the waiting position Sit) for the normal control and is set to a more advanced position (in the x-axis positive direction), controlling the electric motor 11 (the slide shaft 115) so as to output zero as the value S detected based on this control base position S* causes the booster piston 102 to wait at a position shifted from the normal waiting position Sbt in the further advance direction (the x-axis positive direction) (this means that the booster piston 102 cannot be completely returned). As a result, for example, even when the brake pedal 2 is not pressed, a hydraulic pressure may be generated in the master cylinder 10, generating an unintended brake force (abutment of the brake pad against the disk, i.e., a brake drag). The conventional techniques have not paid attention to this problem at all.

On the other hand, in the present first embodiment, after the apparatus 1 is started up, each time an operation amount of the brake pedal 2 is reduced to be smaller than the initial base position Ss (retracted in the x-axis negative direction), the control base position S* is updated to the operation amount at that time. More specifically, as the brake pedal 2 is returned, each time the detection value S of the stroke sensor 17 detected based on the initial base position Ss (or the control base position S* updated last time) is reduced to be smaller than the above-mentioned initial base position Ss (or the control base position S* updated last time), i.e, zero, the detection value S at that time is set as a new control base position S* (zero position). After that, this control base position S* is used as a reference position in the detection of the stroke sensor 17. Therefore, even if the learning is impossible and it is difficult to accurately set the control base position S* as mentioned above, setting a larger initial base position Ss ensures generation of a brake force while enabling correction (update) of the initial base position Ss to the control base position S* closer to an actual value. It is possible to prevent the above-mentioned generation of an unintended brake force, i.e., occurrence of a brake drag by detecting an operation amount of the brake pedal 2 based on the corrected (updated) control base position S* and controlling the position of the booster piston 102 based thereon.

In the present first embodiment, upon establishment of a state allowing learning of the control base position S* of the stroke sensor 17 (more specifically, upon satisfaction of the learning condition such as a return of the brake pedal 2 to the brake release position), the controller 4 learns the control base position S*, and corrects the control base position S* based on this learned value. Therefore, after the brake pedal 2 is returned, it is possible to more accurately set the control base position S*, and ensure further accurate brake control by the apparatus 1. In the present first embodiment, the controller 4 continues updating the control base position S* until execution of the first learning. Therefore, even before the learning, it is possible to not only provide the above-mentioned effect by correcting the control base position S* to a value closer to an actual value, but also further improve the accuracy of the control by continuously performing the correction along with the learning. However, the learning processing may be omitted, and even in this case, it is possible to provide the effect of prevention of generation of an unintended brake force as mentioned above at least until the brake pedal 2 is returned.

The apparatus 1 controls the electric motor 11 so as not to move the booster piston 102 forward, when the detection value S of the stroke sensor 17 is equal to or smaller than the initial base position Ss (zero) while the controller 4 is in a controllable state. That is, in this case, since it is obvious that the initial base position Ss is set to an excessive value, the apparatus 1 does not perform brake control based on the detection value S using this initial base position Ss, and prioritizes execution of update (correction) of the control base position S*. As a result, it is possible to more reliably prevent generation of an unintended brake force. Further, the apparatus 1 controls the electric motor 11 so as to move the booster piston 102 forward by the same amount as the detection value S, when the detection value S is larger than the initial base position Ss while the controller 4 is in a controllable state. As a result, it is possible to improve the reliability of the hydraulic pressure control after the system is started up by a brake operation. Further, since the boosting ratio is kept constant without employing the advance control at an increased boosting ratio and the delay control at a reduced boosting ratio, it is possible to more steadily generate a brake force while more securely preventing generation of an unintended brake force.

### Effects of First Embodiment

In the following, the effects provided by the apparatus 1 according to the first embodiment will be described.

(1) The brake apparatus includes the master cylinder 10 configured to generate the brake hydraulic pressure P, the input member 15 configured to be moved forward and backward by an operation of the brake pedal 2, the stroke detector (the stroke sensor 17) configured to detect an operation stroke (the position Si in the x-axis direction) of the input member 15, the assist member (the booster piston 102) disposed so as to be movable relative to the input member 15, the actuator (the electric motor 11) configured to move the assist member forward and backward by applying an assist thrust force to the assist member, to generate the brake hydraulic pressure P in the master cylinder 10, and the controller 4 configured to be set into a controllable state upon satisfaction of a predetermined condition for starting up a system, and control the actuator based on a detection result of the stroke detector. When the controller 4 is set into the controllable state, the controller 4 sets the stored initial base position Ss as the control base position S* of the stroke detector to control the actuator based on the detection value S of the stroke detector, and each time the input member 15 is moved backward beyond the control base position S*, the controller 4 updates the control base position S* (zero position) of the stroke detector to a position (the detection value S of the stroke detector) of the input member 15 at that time. Therefore, it is possible to prevent generation of an unintended brake force.
(2) The controller 4 is set into the controllable state when the pedal switch (the brake switch), which is configured to detect whether the brake pedal 2 is operated, is connected and then detects that the brake pedal is operated. Therefore, it is possible to more steadily generate a brake force.
(3) The controller 4 learns the control base position S* of the stroke detector when the brake pedal 2 is returned to the brake release position, and the controller continues updating the control base position S* until first execution of the learning. Therefore, it is possible to more accurately provide brake control.
(4) The initial base position Ss may be set to a larger value than the control base position S* learned and stored at the time of previous start-up of the system. In this case, it is possible to eliminate the influence of a factor that may affect an output of the stroke detector (the stroke sensor 17) while the system is stopped
(5) The initial base position Ss is set to a larger value than the value stored at the time of installation of the brake apparatus 1 onto the vehicle. Therefore, it is possible to eliminate the influence of a factor that may affect an output of the stroke detector (the stroke sensor 17) after the apparatus 1 was mounted on the vehicle.
(6) The controller 4 controls the actuator so as not to move the assist member forward when the detection value S of the stroke detector is equal to or smaller than the initial base position Ss while the controller 4 is in the controllable state. Therefore, it is possible to more securely prevent generation of an unintended brake force.
(7) The controller 4 controls the actuator so as to move the assist member forward by the same amount as the detection value S when the detection value S of the stroke detector is larger than the initial base position Ss while the controller 4 is in the controllable state. Therefore, it is possible to more securely prevent generation of an unintended brake force while generating a brake force after start-up of the system.

### Other Embodiments

Although the invention has been described with reference to the first embodiment, it should be understood that the structural details of the present invention is not limited to this first embodiment, and the invention covers all modifications and equivalents within the scope of the appended claims.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2010-244510, filed on Oct. 29, 2010. The entire disclosure of Japanese Patent Application No. 2010-244510, filed on Oct. 29, 2010 including specification, claims, drawings and summary is incorporated herein by reference in its entirety.

What is claimed is:

1. A brake apparatus comprising:
a master cylinder configured to generate a brake hydraulic pressure;
an input member configured to be moved forward and backward by an operation of a brake pedal;
a stroke detector configured to detect an operation stroke of the input member;
an assist member disposed so as to be movable relative to the input member;
an actuator configured to move the assist member forward and backward by applying an assist thrust force to the assist member, to generate the brake hydraulic pressure in the master cylinder; and
a controller configured to be set into a controllable state upon satisfaction of a predetermined condition for starting up a system, and control the actuator based on a detection result of the stroke detector,
wherein, when the controller is set into the controllable state, the controller sets a previously stored initial base position as a control base position of the stroke detector to control the actuator based on the detection value of the stroke detector, and each time the input member is moved backward beyond the control base position, the controller updates the control base position of the stroke detector to a position of the input member at that time.

2. The brake apparatus according to claim 1, wherein the controller is set into the controllable state when the brake pedal is operated.

3. The brake apparatus according to claim 2, wherein the controller is set into the controllable state when a pedal switch, which is configured to detect whether the brake pedal is operated, is connected and then detects that the brake pedal is operated.

4. The brake apparatus according to claim 1, wherein the controller learns the control base position of the stroke detector when the brake pedal is returned to a brake release position, and the controller continues updating the control base position until first execution of the learning.

5. The brake apparatus according to claim 4, wherein the initial base position is set to a larger value than the control base position learned and stored at the time of previous start-up of the system.

6. The brake apparatus according to claim 1, wherein the initial base position is set to a larger value than a value stored at the time of installation of the brake apparatus onto a vehicle.

7. The brake apparatus according to claim 1, wherein the controller controls the actuator so as not to move the assist member forward when the detection value of the stroke detector is equal to or smaller than the initial base position while the controller is in the controllable state.

8. The brake apparatus according to claim 1, wherein the controller controls the actuator so as to move the assist member forward by a same amount as the detection value when the detection value of the stroke detector is larger than the initial base position while the controller is in the controllable state.

9. The brake apparatus according to claim 1, wherein the controller performs the setting and the update of the control base position when the controller is set into the controllable state while an ignition switch of a vehicle is turned off.

10. A brake apparatus comprising:
a master cylinder configured to generate a brake hydraulic pressure;
an input member configured to be moved forward and backward by an operation of a brake pedal;
a stroke detector configured to detect an operation stroke of the input member;
an actuator configured to move an assist member forward and backward, the assist member being capable of generating the brake hydraulic pressure in the master cylinder; and
a controller configured to be set into a controllable state upon an operation of the brake pedal, and control the actuator based on a detection result of the stroke detector,
wherein, when the controller is set into the controllable state, the controller sets a previously stored initial base position as a control base position of the stroke detector, and controls the actuator so as to move the assist member forward or backward to a position based on the detection value of the stroke detector, and each time the input member is moved backward beyond the control base position, the controller updates the control base position of the stroke detector to a position of the input member at that time.

11. The brake apparatus according to claim 10, wherein the controller is set into the controllable state when a pedal switch, which is configured to detect whether the brake pedal is operated, is connected and then detects that the brake pedal is operated.

12. The brake apparatus according to claim 10, wherein the controller learns the control base position of the stroke detector when the brake pedal is returned to a brake release position, and the controller continues updating the control base position until first execution of the learning.

13. The brake apparatus according to claim 12, wherein the initial base position is set to a larger value than the control base position learned and stored at the time of previous start-up of the system.

14. The brake apparatus according to claim 10, wherein the initial base position is set to a larger value than a value stored at the time of installation of the brake apparatus onto a vehicle.

15. The brake apparatus according to claim 10, wherein the controller controls the actuator so as not to move the assist member forward when the detection value of the stroke detector is equal to or smaller than the initial base position while the controller is in the controllable state.

16. The brake apparatus according to claim 10, wherein the controller controls the actuator so as to move the assist member forward by a same amount as the detection value when the detection value of the stroke detector is larger than the initial base position while the controller is in the controllable state.

17. The brake apparatus according to claim 10, wherein the controller performs the setting and the update of the control base position when the controller is set into the controllable state while an ignition switch of a vehicle is turned off.

18. A brake apparatus comprising:
a master cylinder configured to generate a brake hydraulic pressure;
a stroke detector configured to detect an operation amount of a brake pedal; and
a controller configured to be set into a controllable state upon an operation of the brake pedal, and control an actuator based on a detection result of the stroke detector, the actuator being configured to move forward or backward an assist member capable of generating the brake hydraulic pressure in the master cylinder,
wherein, when the controller is set into the controllable state, the controller sets a previously stored initial base position as a control base position of the stroke detector, and controls the actuator so as to move the assist member forward or backward to a position based on the detection value of the stroke detector, and each time the brake pedal is moved backward beyond the control base position after the operation of the brake pedal is released, the controller updates the control base position of the stroke detector to an operation position of the brake pedal at that time.

19. The brake apparatus according to claim 18, wherein the controller learns the control base position of the stroke detector when the brake pedal is returned to a brake release position, and the controller continues updating the control base position until first execution of the learning.

20. The brake apparatus according to claim 18, wherein the initial base position is set to a larger value than a value stored at the time of installation of the controller onto a vehicle.
